(19) United States
(12) Patent Application Publication
(10) Pub. No.: US 2006/0175430 A1
(43) Pub. Date: Aug. 10, 2006

(54) Fire-extinguishing mist projector

(76) Inventor: Carsten Bardehle, Hamburg (DE)

Correspondence Address: RANKIN, HILL, PORTER & CLARK LLP, 4080 ERIE STREET, WILLOUGHBY, OH, 44094-7836, US

(21) Appl. No.: 10/567,608

(22) PCT Filed: Aug. 17, 2004
(86) PCT No.: PCT/EP04/09215

§ 371 Date: Feb. 8, 2006

(30) Foreign Application Priority Data
Aug. 19, 2003 (DE) 103 37 963.0

(51) Int. Cl. B05B 3/06

(52) U.S. Cl. 239/251; 239/263; 239/225.1; 239/550; 169/37

(57) ABSTRACT

The invention relates to a fire-extinguishing mist projector (1) for producing a jet of mist oriented along an injection jet axis (7). Said mist projector comprises an ejector (8) which is supplied with high-pressure water, generates a jet of water (10) parallel to the injection jet axis (7), and is arranged in such a way that it can rotate about the injection jet axis (7). The inventive mist projector is characterized in that the projector is surrounded by a open-ended jacket tube (11) that is concentric to the injection jet axis (7).

### BACKGROUND OF THE INVENTION

The present invention relates to a misting fire extinguisher nozzle system.

Misting fire extinguishers are increasingly significant in fire fighting. In a mist of very fine droplets, water is present at a very high surface-volume ratio. As a result, the flames are cooled considerably and hence fire extinguishing is very effective. Furthermore, a fine mist also scrubs smoke and hence damps troublesome smoke generation.

Misting fire extinguishers are known which are able to generate short-duration mist pulses by means of high pressure gases but entail very elaborate designs.

When generating mists using an ejector to which highly pressurized water is applied, commercially available atomizing ejectors may be used which can directly generate a mist on account of their design. Such misting ejectors offer the advantage of continuous operation and simple design, but they incur the drawback of short operational ranges and therefore can be used in fire fighting in only a very restricted manner.

A misting fire extinguisher of the above species is disclosed in U.S. Pat. No. 5,284,298. Therein, an ejector rotating about an axis generates a helical jet of water to which is imparted a forward momentum. As a result, air is entrained and the water jet is converted into a mist. Appropriate ejectors are commercially available, for instance to receive inputs of about 100 bars from high-pressure cleansing equipment to the ejectors.

This known design however incurs the drawback of a restricted operating range of the mist jet.

U.S. Pat. No. 4,715,539 shows a high-pressure cleaning equipment nozzle mounted in a stationary manner to the equipment and enclosed to the rear by a pipe serving as a grip.

### BRIEF SUMMARY OF THE INVENTION

The object of the present invention is to create a misting fire extinguisher of larger range of operation.

The invention uses a concentric casing tube open at both ends and reinforcing the jet's air entraining effect, thereby enormously enlarging the range of the mist jet. The range of the water jet, per se, is exceeded significantly. An air blower is not needed. The design of the invention is able to generate jets of mist of very large ranges, beyond 10 meters, that consist of ultrafine water droplets which are exceedingly effective regarding extinction and smoke scrubbing.

The ejector may be driven, in rotation for instance, by a motor. Provided the ejector's jet direction tilts slightly backward toward the circumferential direction of rotation, it shall be self-propelling in the manner of a lawn sprinkler and any drive motor is superfluous.

Optimal misting and a large range of the misting jet is attained in compact manner. Atomization and misting output are increased for instance using two mutually opposite ejectors.

One misting fire extinguisher of the invention is shown schematically as an illustrative embodiment mode in the drawing.

### BRIEF DESCRIPTION OF THE DRAWINGS

FIG. 1 is a section along line 1-1 in FIG. 2 and

FIG. 2 is a section along line 2-2 in FIG. 1.

### DETAILED DESCRIPTION OF THE INVENTION

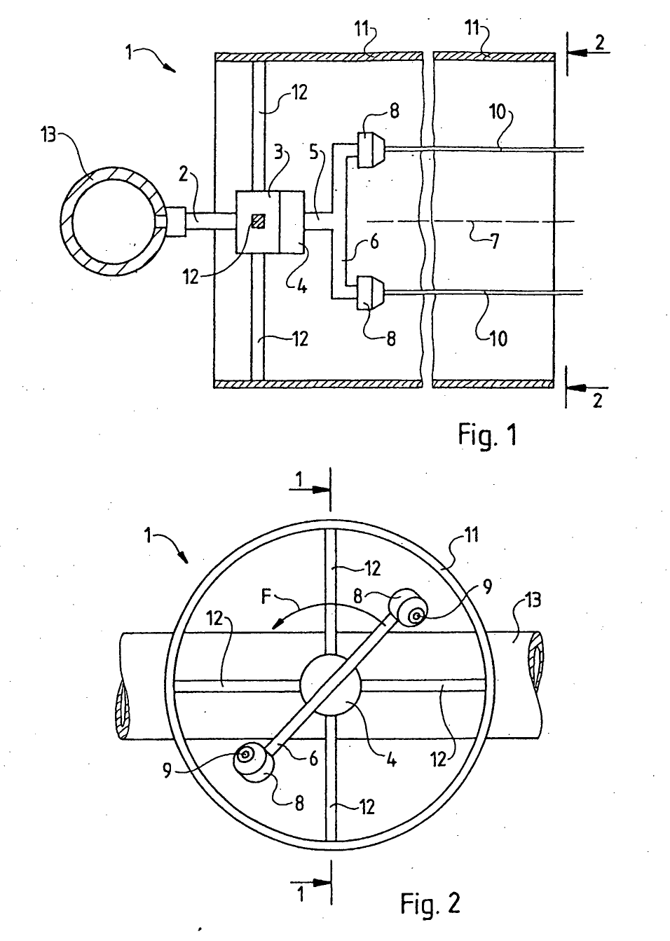

In different sections, FIGS. 1 and 2 show a misting fire extinguisher nozzle system 1 fitted with a feed tube 2 (FIG. 1) through which highly pressurized water, for instance at 100 bars, is fed to the stationary element 3 of a tubular pivot bearing 3, 4 of which the rotary element 4, via a tube 5 configured in the axis of the pivot bearing, feeds a transverse tube 6. Two ejectors 8 are configured at the ends of the transverse tube 6 equidistantly from the axis of rotation 7, which by means of their jet ports 9 (FIG. 2) generate water jets 10 parallel to the axis of rotation 7.

The rotatable component 4, 5, 6, 8 of the assembly shown is driven in the direction of rotation denoted by the arrow F in FIG. 2. A separate motor such as a hydraulic motor or an electric motor might be used for that purpose. However, in the embodiment shown said rotation is implemented in very simple manner as in a lawn sprinkler by slightly tipping the direction of the water ports 9 opposite the direction of rotation F as shown in FIG. 2. Illustratively, the angle subtended between the water jets 10 and the perpendicular to the plane of the drawing of FIG. 2 may be 5°.

A casing tube 11 is configured around the nozzle system shown and exhibits a diameter larger than the circular path of the ejectors 8 while its length is approximately twice the circumference. The casing tube 11 begins at its rear end at least at the ejectors 8 and its length preferably is twice its diameter. In one embodiment, the diameter is about 15 cm and the length is about 30 cm. In this embodiment, the casing tube 11 is affixed by four struts 12 to the stationary component 3 of the tubular pivot bearing 3, 4. The misting fire extinguisher nozzle system 1 shown may be portable, for instance, for manual handling. In that case it must be hooked up to the feed tube 2 by a hose (not shown).

In the embodiment shown, the misting fire extinguisher nozzle system 1 is connected in a stationary manner to a supply pipe 13 which illustratively is fixed inside a building and connected to a high pressure water pump. Further misting fire extinguishers nozzle systems may be configured mutually apart along the pipe 13. Illustratively, such a network may be used in a traffic tunnel.

In operation the misting fire extinguisher nozzle system 1 is supplied via the feed tube 2 with water pressurized, for instance at 100 bars, and applied, for instance through the pivot bearing 3, 4, to the ejectors 8. By means of their water ports 9, the ejectors generate two water jets 10 running in the same direction as the axis 7 which, when assuming the above mentioned slight tipping, implement the rotary drive motion applied to the ejectors in the direction of the arrow F.

The still unatomized solid water jets 10 exiting from the ejectors 8 illustratively are a few tenths of a mm in diameter, therefore, move along helical paths in the same direction as the axis of rotation 7 and, aided by the casing tube 11, they entrain a high-speed airflow. At the terminal end (as seen in the direction of the jets) of the casing tube 11, a fine jet of mist is then present which, for the aforementioned dimensions of the misting fire extinguisher nozzle system 1, attains an operational range larger than 10 m, and at such a distance exhibits a diameter of several m. The droplets of the generated mist are exceedingly small, and therefore said mist will not settle on the ground, but instead may be carried away as cloud by appropriate airflows.

In the embodiment shown, the misting fire extinguisher nozzle system 1 is fitted with two ejectors 8. However only one ejector may also be used, or for instance three or more.

Omitted alternatives also are feasible.

Illustratively, at the suction side of the casing tube 11, an air blower driven by a separate motor may be used to advantageously increase airflow.

The rotational speed of the ejectors 8 may be advantageously regulated or decelerated to slightly reduce the misting effect. In this manner the droplet size, the operational range and the penetration momentum of the mist jet each are increased.

The last two cited design variations may be combined into one simple variation where the ejectors directly drive a ventilating wheel affixed in simple manner to the transverse tube 6, said wheel simultaneously acting in a two-fold manner, namely as a blower and as an air brake decelerating the rotational speed.

1. A misting nozzle system (12) generating a mist jet directed parallel to a jet axis (7) and comprising an ejector (8) which is fed with highly pressurized water and which generates a water jet (10) running parallel to the jet axis (7) and which is configured to rotate about said jet axis, wherein the nozzle system is enclosed by a casing tube (11) that is open at both its ends and concentric with the jet axis (7).

2. The misting nozzle system as claimed in claim 1, wherein the ejector (8) generates the water jet (10) to be slightly tilted relative to the circumferential direction of rotation (F).

3. The misting nozzle system as claimed in claim 1, wherein the casing tube (11) extends rearward at least as far as the ejector (8).

4. The misting nozzle system as claimed in claim 1, wherein the length of the casing tube (11) is at least twice its diameter.

5. The misting nozzle system as claimed in claim 1, wherein at least one more ejector is/are mounted spaced apart on the circumferential path of the ejector (8).
